(19) United States
(12) Patent Application Publication
(10) Pub. No.: US 2012/0302386 A1
(43) Pub. Date: Nov. 29, 2012

(54) TRIPLE HYBRID TRANSMISSION SYSTEM

(75) Inventor: Joshua Zulu, Germantown Hills, IL (US)

(73) Assignee: Caterpillar Inc., Peoria, IL (US)

(21) Appl. No.: 13/115,222

(22) Filed: May 25, 2011

(51) Int. Cl. F16H 47/08; F16H 47/06; F16H 41/24

(52) U.S. Cl. 475/1; 60/364; 74/665 A

(57) ABSTRACT

A hybrid transmission system for providing a variable speed and torque output from a mechanical power source and a hydraulic power source. The hybrid transmission system includes a stationary housing, an input shaft and an output shaft. The input and the output shafts are mounted within the stationary housing for rotation about a central axis. The hybrid transmission system further includes a rotatable housing, a hydraulic rotor and an electric unit associated to the rotatable housing or the input shaft. The rotatable housing is connected to the input shaft to drive the output shaft. The hydraulic rotor is mounted within the rotatable housing and rotatably coupled to the output shaft. The hydraulic rotor is configured to be selectively engaged and disengaged to the rotatable housing. The hybrid transmission system provides an option to recover, store and discharge excess electrical energy.

### TECHNICAL FIELD

The present disclosure relates to transmission systems and, more particularly to a hybrid transmission system for providing a variable speed and torque output from a mechanical power source and a hydraulic power source, with an option to recover, store and discharge excess electrical energy.

### BACKGROUND

Hybrid transmission systems are employed in various vehicles and machines for providing variable speed and torque outputs from a power source, such as an internal combustion engine. Various hybrid transmission systems are well known in the art, for example, a hydro-mechanical transmission disclosed in U.S. Pat. No. 5,396,768, issued to Zulu on Mar. 14, 1995 (“the '768 patent”). The hydro-mechanical transmission of the '768 patent includes a hydraulic motor that is entirely rotatable. The entirely rotatable hydraulic motor enables the hydro-mechanical transmission to provide a variable speed and torque output from an external mechanical power source and an external hydraulic power source.

### SUMMARY

In one aspect, the present disclosure provides a hybrid transmission system to provide a variable speed and torque output from a mechanical power source and a hydraulic power source. The hybrid transmission system includes a stationary housing, an input shaft, and an output shaft. The input and the output shafts are mounted within the stationary housing and rotatably coupled for rotation about a central axis. The hybrid transmission system further includes a rotatable housing and a hydraulic rotor. The rotatable housing is also mounted within the stationary housing for rotation about the central axis. The rotatable housing may be connected to the input shaft to drive the output shaft. The hydraulic rotor is mounted within the rotatable housing in a coaxial alignment with the input shaft and the output shaft. The hydraulic rotor drives the output shaft. Moreover, the hydraulic rotor may be configured to be selectively engaged and disengaged to the rotatable housing.

Other features and aspects of present disclosure will be apparent from the following description and the accompanying drawings.

### BRIEF DESCRIPTION OF THE DRAWINGS

FIG. 1 is a schematic diagram of a machine having a hybrid transmission system, according to an aspect of present disclosure;

FIG. 2 is a schematic diagram of the hybrid transmission system shown in FIG. 1, according to an aspect of present disclosure;

FIG. 3 is a schematic diagram of the hybrid transmission system, according to another aspect of present disclosure; and

FIG. 4 is a schematic diagram of the hybrid transmission system, according to yet another aspect of present disclosure.

### DETAILED DESCRIPTION

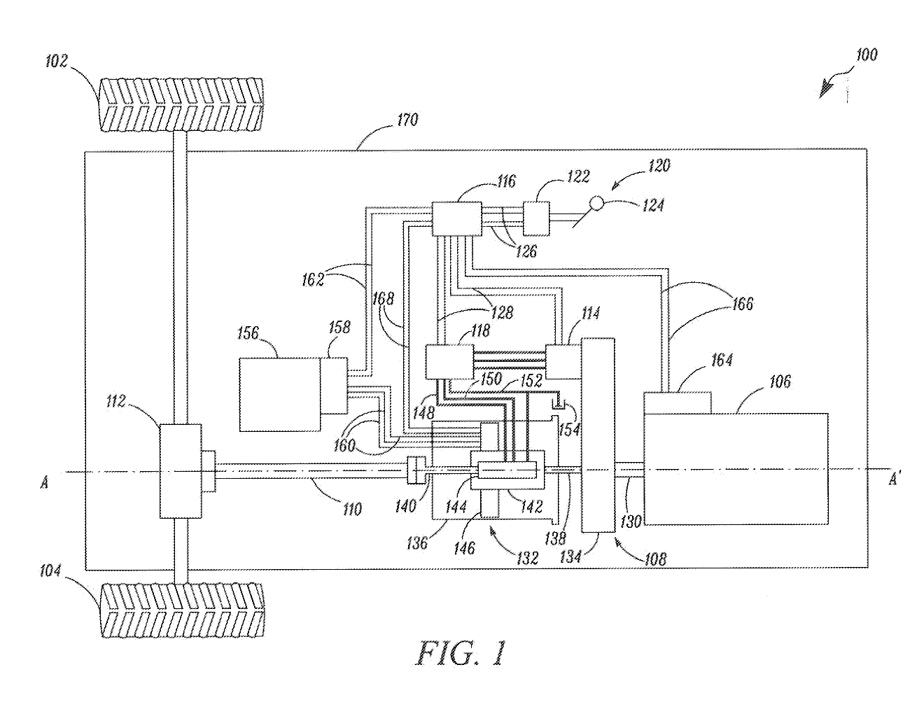

FIG. 1 shows a schematic diagram of a machine 100, according to an aspect of present disclosure. The machine 100 may include a tracked or a wheeled vehicle, for example, but not limited to, off-highway trucks, on-highway trucks, articulated trucks, wheel tractors, track-type tractors, wheel tractor-scrapers, wheel loaders, compactors, excavators, dozers, motor graders, any moving machine, or other machine providing torque and speed outputs using a transmission system. As shown in FIG. 1, the machine 100 may embody a wheeled vehicle having a first wheel 102 and a second wheel 104.

The machine 100 may include a mechanical power source, such as an internal combustion engine 106, a drive train 108, and a driven shaft 110. The driven shaft 110 may be drivably connected to the drive train 108 and configured to transmit torque and rotation to the first wheel 102 and the second wheel 104 via a differential assembly 112. The differential assembly 112 may, but is not required to, employ a plurality of gears.

The machine 100 may further include a hydraulic power source, such as a fixed displacement (for open loop circuit) or a variable displacement (for closed loop circuit) hydraulic pump 114. The hydraulic pump 114 may be of any well known construction and type, such as, a gear pump, a rotary vane pump, a screw pump, an axial piston pump or a radial piston pump. Further, the hydraulic pump 114 may be controlled by a programmable logic controller (PLC) 116 and an electro-hydraulic interface and control valve module 118 in response to an operator's command using a control lever 120.

The programmable logic controller 116 may include a microcomputer, microprocessor, or a programmable logic array (PLA), or the like capable of being programmed. The programmable logic controller 116 may be configured to receive and process various voltage or current signals. The control lever 120 may include a position sensor 122 operatively connected to a actuating handle 124. The position sensor 122 may be electrically coupled to the programmable logic controller 116 by a first set of electrical signal lines 126, and may provide signals based on the operator's command using the control lever 120. Further, the programmable logic controller 116 may be electrically coupled to the hydraulic pump 114 and the electro-hydraulic interface and control valve module 118 by a second set of electrical signal lines 128.

The electro-hydraulic interface and control valve module 118 may receive electronic reference signals from the programmable logic controller 116 via the second set of electrical signal lines 128. In response to the received electronic reference signals, the electro-hydraulic interface and control valve module 118 may regulate the pressure and/or flow from the hydraulic pump 114. In an embodiment, the electro-hydraulic interface and control valve module 118 may include an electro-hydraulic transducer valve assembly having a rotary valve or a sliding piston valve. However, based on an open loop circuit or a closed loop circuit configuration, various type of electro-hydraulic transducer valve assemblies, which may proportionally control and vary the pressure and/or flow based on the received electronic reference signal, can be used with the hydraulic pump 114.

As shown in FIG. 1, the drive train 108 may include a drive shaft 130 to interconnect the internal combustion engine 106 with a hybrid transmission system 132. The drive train 108 may also include a gear reduction unit 134 that is interposed in the drive train 108 between the internal combustion engine 106 and the hybrid transmission system 132. In various embodiments, the drive train 108 may include a belt drive, a friction drive, or the like. Further, the drive train 108 may include a set of gears to power the hydraulic pump 114.

In an embodiment, the hybrid transmission system 132 may include a stationary housing 136, an input shaft 138, an output shaft 140, and a rotatable housing 142. The input shaft 138 and the output shaft 140 may be mounted within the stationary housing 136 and may rotate about a central axis AA′. The input shaft 138 and the output shaft 140 may be rotatably coupled to the stationary housing 136, such that the input shaft 138 and the output shaft 140 may be drivably coupled to the drive shaft 130 and the driven shaft 110, respectively. In an embodiment, the input shaft 138 and the output shaft 140 may include an annular hub having internal splines at respective distal ends to couple the input shaft 138 and the output shaft 140 with the drive shaft 130 and the driven shaft 110, respectively. The rotatable housing 142 may be also mounted within the stationary housing 136 and may rotate about the central axis AA′ via the input shaft 138.

In an embodiment, the hybrid transmission system 132 may further include a hydraulic rotor 144 and an electric unit 146. The hydraulic rotor 144 may be an axial piston motor, a radial piston motor, or a vane type motor. Alternatively, the hydraulic rotor may be a low speed, high torque type motor of any other well-known construction. It should be understood that the present disclosure is not intended to be limited to a particular motor type, as those skilled in the art will readily be able to adapt to various types of motors, for example, a radial or an axial piston type hydraulic motor, without departing from the teachings hereof. The hydraulic rotor 144 may be mounted within the rotatable housing 142 in coaxial alignment with the input shaft 138 and the output shaft 140, i.e., about the central axis AA'. As shown in FIG. 1, a first hydraulic line 148 and a second hydraulic line 150 may connect the hydraulic pump 114 to the hydraulic rotor 144 through the electro-hydraulic interface and control valve module 118. Further, a drainage hydraulic line 152 may be provided that connects the hydraulic pump 114 and the hydraulic rotor 144 to a reservoir 154 for draining off any fluid leakage. In an embodiment, the rotatable housing 142 and the hydraulic rotor 144 may be coupled to the output shaft 140. Further, the hydraulic rotor 144 may be configured to be selectively engaged and disengaged to the rotatable housing 142.

In an embodiment, the electric unit 146 may be associated with the rotatable housing 142 and include an electric motor, for example, an alternating current (AC) motor or a direct current (DC) motor of any well-known construction. Further, the electric unit 146 may work as an electric motor, converting electrical energy into mechanical energy, to selectively drive the rotatable housing 142. Alternatively, the electric unit 146 may work as an electric generator, converting mechanical energy into electrical energy, to produce electrical energy via the rotation of the rotatable housing 142 or the input shaft 138. In a downhill vehicle retarding mode where the output shaft 140 is being driven by kinetic energy from machine momentum or braking demand, the electric unit 146 may also work as an electric generator, converting kinetic energy into electrical energy via the rotation of the rotatable housing 142.

Additionally, the machine 100 may include a battery 156 and a battery charge/discharge control module 158. The battery 156 may be any rechargeable battery such as a lead-acid battery, a nickel cadmium (NiCd) battery, a nickel metal hydride (NiMH) battery, a lithium ion (Li-ion) battery, a lithium ion polymer (Li-ion polymer) battery, or the like. Alternatively, the battery 156 may include a set of batteries or individual electrochemical cells forming a battery pack. The battery 156 and the battery charge/discharge control module 158 may be electrically connected to the electric unit 146 using electrical wires 160. The battery charge/discharge control module 158 may control the voltage and the current levels in the battery 156, and avoid overcharging or over-discharging of the battery 156 by means of the electric unit 146. The battery charge/discharge control module 158 may also include switches or relays to toggle electrical contact between the battery 156 and the electric unit 146 during charging or discharging process. The battery charge/discharge control module 158 may interact with the programmable logic controller 116 via a third set of electrical signal lines 162.

An engine control module (ECM) 164 may be associated with the internal combustion engine 106, and may be connected to the programmable logic controller 116 using a fourth set of electrical signal lines 166. It may be apparent to those skilled in the art that the ECM 164 may control operation of various components associated with the internal combustion engine 106, such as, amount of fuel injected into each cylinder, ignition timing, valve timing, and the like. The ECM 164 may provide performance parameters and/or performance limits of the internal combustion engine 106 to the programmable logic controller 116. Based on the received performance parameters and/or performance limits of the internal combustion engine 106, the programmable logic controller 116 may control the operation of the battery charge/discharge control module 158. In an embodiment, the programmable logic controller 116 may be incorporated in the ECM 164.

Moreover, a fifth set of electrical signal lines 168 may couple the electric unit 146 to the programmable logic controller 116. The programmable logic controller 116 may receive status and/or feedback from the electric unit 146 using the fifth set of electrical signal lines 168.

The machine 100 may further include a chassis portion 170 which may support the one or more components of the mechanical power source, the hydraulic power source, the differential assembly 112, the transmission system 132, and the battery 156.

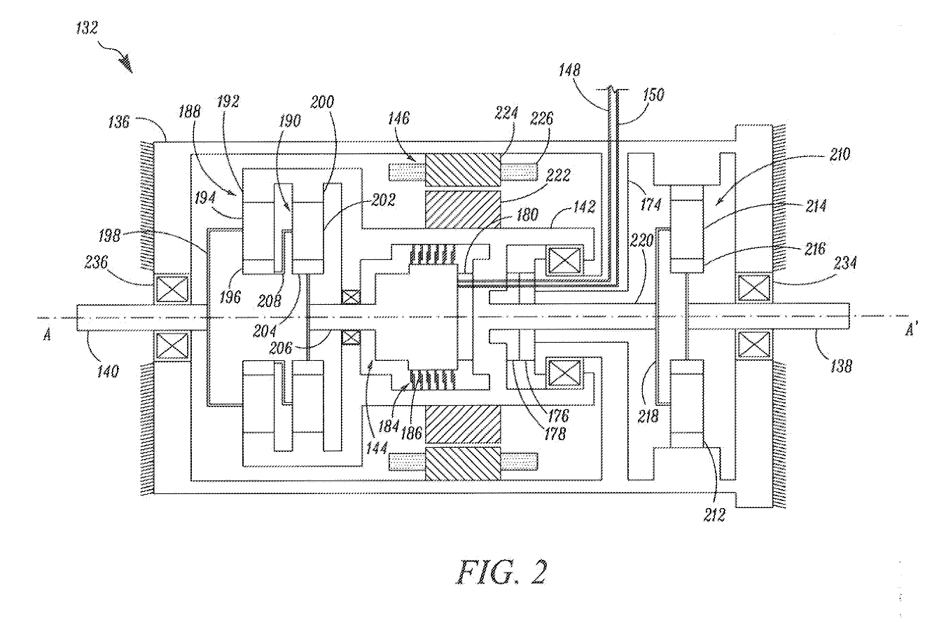

FIG. 2 shows a schematic diagram of the hybrid transmission system 132, shown in FIG. 1. The first hydraulic line 148 and the second hydraulic line 150 may be connected to the hydraulic rotor 144, through a hydraulic manifold 174 and a dual path port plate 176. Further, a pressure plate 178 forming a swivel joint may be provided between the dual path port plate 176 and the rotatable housing 142 to continuously supply the pressurized fluid while the rotatable housing 142 rotates. The swivel joint may provide a hydrodynamic sealing force proportional to the supplied pressure and also continuously adjust for any wear. Moreover, a rotor port plate 180 may be provided between the hydraulic rotor 144 and the rotatable housing 142 to supply the pressurized fluid for rotation of the hydraulic rotor 144 relative to the rotatable housing 142.

The hybrid transmission system 132 may include a clutch member 184 to selectively engage and disengage the hydraulic rotor 144 to the rotatable housing 142. The clutch member 184 may be associated with the rotatable housing 142 and include a set intermeshed disk portions 186 which may be connected to the rotatable housing 142 and the hydraulic rotor 144. Further, a mechanical or hydraulic mechanism may be provided to selectively engage and disengage the set intermeshed disk portions 186 of the clutch members 184.

The hybrid transmission system 132 may further include a first gear assembly 188 and a second gear assembly 190. The first gear assembly 188 may be coupled to the rotatable housing 142. As shown in FIG. 2, the first gear assembly 188 may include a planetary gearing mechanism having a ring gear 192, a set of planet gears 194, and a sun gear 196. The ring gear 192 of the first gear assembly 188 may be coupled to the rotatable housing 142 to receive a rotational movement therefrom. The ring gear 192 may drive the set of planet gears 194 which in turn may drive a carrier member 198 connected to the set of planet gears 194. The carrier member 198 may be drivably connected to the output shaft 140.

The second gear assembly 190 may also include a planetary gearing mechanism having a ring gear 200, a set of planet gears 202, and a sun gear 204. The ring gear 200 of the second gear assembly 190 may also be coupled to the rotatable housing 142 to receive a rotational movement therefrom. The first gear assembly 188 and the second gear assembly 190 may be designated as first planetary reduction and second planetary reduction respectively. The first gear assembly 188 is added as an optional configuration to add more output speed reduction, if required, between the rotatable housing 142 and the hydraulic rotor 144. Without the first gear assembly 188, the output shaft 140 is directly coupled to the planet carrier 208 of the second gear assembly 190. The sun gear 204 may be coupled to the hydraulic rotor 144, via a hydraulic rotor output shaft 206 to receive a rotational movement therefrom. The sun gear 204 of the second gear assembly 190 may drive the set of planet gears 202 which in turn drive a carrier member 208. The carrier member 208 of the second gear assembly 190 may be coupled to the sun gear 196 of the first gear assembly 188. Thus, the first gear assembly 188 and the second gear assembly 190 may provide a combined dual reduction output between the rotatable housing 142 and the hydraulic rotor 144 to the output shaft 140. The ring gears 192 and 200 rotate at the same speed as the rotatable housing 142. Output speed variation is achieved by disengaging the clutch member 184 to allow the hydraulic rotor 144 to rotate relative to the rotatable housing 142. Output speed of the output shaft 140 is determined by the relative speed between the hydraulic rotor 144 and the rotatable housing 142. This relative speed is determined by the combined reduction ratios of the first gear assembly 188 and the second gear assembly 190.

Moreover, the hybrid transmission system 132 may also include a third gear assembly 210 provided between the input shaft 138 and the rotatable housing 142. The third gear assembly 210 may also include a planetary gearing mechanism having a ring gear 212, a set of planet gears 214, and a sun gear 216. The sun gear 216 may be coupled to the input shaft 138 to receive a rotational movement therefrom. The sun gear 216 may drive the set of planet gears 214 which in turn drive a carrier member 218. The carrier member 218 of the third gear assembly 210 may be connected to the rotatable housing 142 via an intermediate shaft 220. The purpose of the third gear assembly 210 is to provide an option to reduce the speed of the input shaft 138 while increasing the torques output in the intermediate shaft 220. It may be evident to those skilled in the art, based on alternative aspects of present disclosure, the first, the second and the third gear assemblies 188, 190 and 210 may be any type gear mechanism, for example, but not limited to, a pinion and wheel gear mechanism with spur, helical or double helical teeth configuration.

As shown in FIG. 2, the electric unit 146 may be associated with the rotatable housing 142. The electric unit 146 includes a rotor member 222 and a stator member 224 provided with a plurality of windings 226. The rotor member 222 may be coupled with the rotatable housing 142 and may be made of a permanent magnet or an electromagnet. The stator member 224 may be coupled with the stationary housing 136, such that, a gap is provided between the rotor member 222 and the stator member 224. The electric unit 146 may be configured to selectively drive the rotatable housing 142 when a current is provided to the stator member 224 from the battery 156 (see FIG. 1) using the electrical wires 160. Alternatively, the electric unit 146 may charge the battery 156 when the rotor member 222 rotates with the rotatable housing 142.

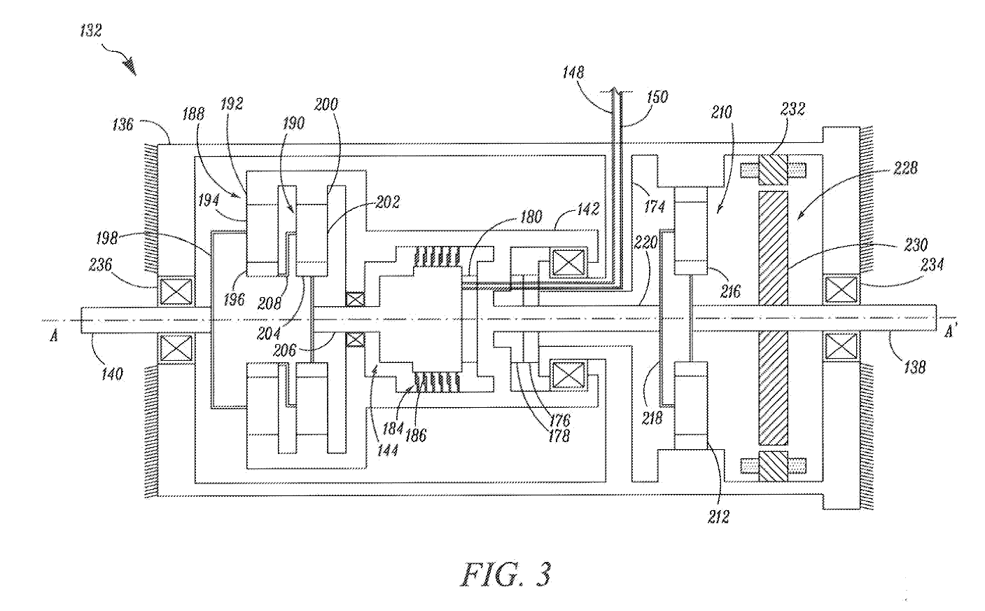

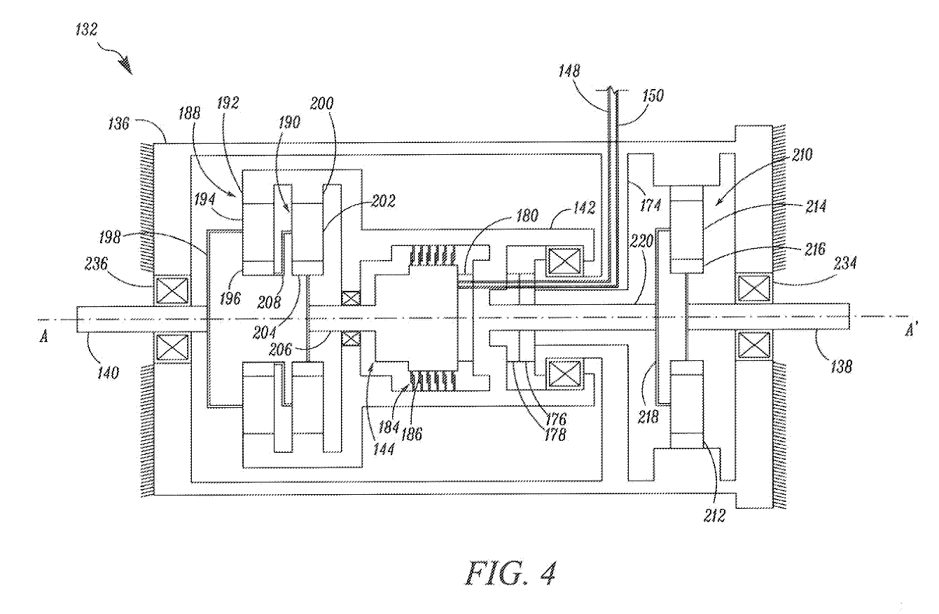

FIG. 3 shows an alternate configuration for hybrid transmission system 132 by having an electric unit 228, according to another aspect of present disclosure. The electric unit 228 may include a rotor member 230 coupled with the input shaft 138 and a stator member 232 coupled with the stationary housing 136. Further, the electric unit 228 may be configured to selectively drive the input shaft 138 when a current is provided to the stator member 232 from the battery 156 to supplement power from the internal combustion engine 106 when required. Alternatively, the electric unit 228 may charge the battery 156 when the rotor member 230 rotates with the input shaft 138 due to input from the internal combustion engine 106 and/or kinetic energy recovery mode. According to yet another embodiment of present disclosure, as shown in FIG. 4, the electric unit 146 or 228 may be absent in the hybrid transmission system 132.

Moreover, a typical bearing support 234 may be provided between the stationary housing 136 and the input shaft 138 to allow a constrained relative motion therebetween. However, another bearing supports 236 may also be provided between the output shaft 140 and the stationary housing 136.

### INDUSTRIAL APPLICABILITY

The hybrid transmission system 132 of present disclosure provides a continuously variable speed and torque output from the mechanical power source and the hydraulic power source. During operation of the machine 100, input from the mechanical power source, such as the internal combustion engine 106, is transferred through the input shaft 138 to the rotatable housing 142, thereby rotating the rotatable housing 142. Further, the programmable logic controller 166 may control the flow of fluid from the hydraulic power source, such as the hydraulic pump 114, to provide a variable input through the hydraulic rotor 144. In an aspect, a combined output of the constant input and the variable input from the internal combustion engine 106 and the hydraulic pump 114 respectively, may be transmitted to the output shaft 140 via the first and the second gear assemblies 188 and 190. Further, the first and the second gear assemblies 188 and 190 being planetary gearing mechanisms allow the hybrid transmission system 132, the drive shaft 130, and the driven shaft 110 to be co-axially arranged about the central axis AA'. In view of the foregoing, present disclosure provides a compact hybrid transmission system 132 to provide smooth and continuously controlled speed and torque output.

Moreover, the hydraulic rotor 144 may be disengaged from the rotatable housing 142 using the clutch member 184. Therefore the hydraulic rotor 144 may rotate independent of the rotatable housing 142. Thus, the combined output of the rotatable housing 142 and the hydraulic rotor 144 may provide a variable speed and torque output at the output shaft 140 via the first and the second gearing assemblies 188 and 190. Alternatively, the hydraulic rotor 144 may be engaged with the rotatable housing 142. The combined output at the output shaft 140 may be equal to the mechanical input shaft 220.

In another aspect of present disclosure, an electric unit, such as the electric unit 146 or 228 associated with one of the rotatable housing 142 and the input shaft 138. The electric unit 146 or 228 may act as an electric motor to provide another means for adding torque and speed to the rotatable housing 142 and the output shaft 140. This battery generated torque and speed would be used to supplement the speed and torque generated by the internal combustion engine 106 to climb a hill or during acceleration. When the electric unit 146 or 228 acts as the electric motor, the battery charge/discharge control module 158 may allow the battery 156 to provide current to the electric unit 146 or 228 to rotate the rotatable housing 142 or the input shaft 138, thereby supplementing the constant input from the internal combustion engine 106. In such embodiment of the present disclosure, a hybrid output may be obtained. Specifically, a triple hybrid combination of mechanical, hydraulic and electric output may be obtained though the hybrid transmission system 132.

Moreover, the programmable logic controller 116 may detect a braking or an engine retarder status from the ECM 164, for example during a down hill decent. When a braking is detected, the electric unit 146 or 228 may act as an electric generator to recover electrical energy. The programmable logic controller 116 may switch the battery charge/discharge control module 158 into a charging mode, such that the recovered electrical energy may be stored in the battery 156. The stored energy in the battery 156 may be used to start the internal combustion engine 106 and/or drive one or more auxiliary components of the machine 100, for example, the hydraulic pump 114.

Aspects of present disclosure may also be applied to vehicles, both wheeled and tracked vehicle. Although the embodiments of present disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A hybrid transmission system for providing a variable speed and torque output from a mechanical power source and a hydraulic power source, the hybrid transmission system comprising:
a stationary housing;
an input shaft and an output shaft mounted within the stationary housing for rotation about a central axis, the input shaft and the output shaft are rotatably coupled to the stationary housing;
a rotatable housing mounted within the stationary housing for rotation about the central axis, the rotatable housing being connected to the input shaft to drive the output shaft; and
a hydraulic rotor mounted within the rotatable housing in a coaxial alignment with the input shaft and the output shaft, the hydraulic rotor drives the output shaft, the hydraulic rotor being configured to be selectively engaged and disengaged to the rotatable housing.

2. The hybrid transmission system of claim 1 further including a clutch member associated with the rotatable housing to selectively engage and disengage the hydraulic rotor to the rotatable housing.

3. The hybrid transmission system of claim 1 further including an electric unit associated to one of the rotatable housing and the input shaft.

4. The hybrid transmission system of claim 3, wherein the electric unit is configured to selectively drive one of the rotatable housing and the input shaft.

5. The hybrid transmission system of claim 3, wherein the electric unit is configured to selectively generate electrical energy with the rotation of one of the rotatable housing and the input shaft.

6. The hybrid transmission system of claim 1 further including:
a first gear assembly driven by the rotatable housing, and
a second gear assembly driven by the hydraulic rotor, the second gear assembly being coupled to the first gear assembly to provide a combined output to drive the output shaft.

7. The hybrid transmission system of claim 6, wherein one of the first gear assembly and the second gear assembly is a planetary gearing mechanism.

8. The hybrid transmission system of claim 1, wherein the hydraulic rotor is one of an axial piston motor, a radial piston motor, and a vane type motor.

9. A hybrid transmission system for providing a variable speed and torque output from a mechanical power source and a hydraulic power source, the hybrid transmission system comprising:
a stationary housing;
an input shaft and an output shaft mounted within the stationary housing for rotation about a central axis, the input shaft and the output shaft are rotatably coupled to the stationary housing;
a rotatable housing mounted within the stationary housing for rotation about the central axis, the rotatable housing being connected to the input shaft to drive the output shaft;
a hydraulic rotor mounted within the rotatable housing in a coaxial alignment with the input shaft and the output shaft, the hydraulic rotor drives the output shaft, the hydraulic rotor being configured to be selectively engaged and disengaged to the rotatable housing; and
an electric unit associated to one of the rotatable housing and the input shaft.

10. The hybrid transmission system of claim 9 further including a clutch member associated with the rotatable housing to selectively engage and disengage the hydraulic rotor to the rotatable housing.

11. The hybrid transmission system of claim 9, wherein the electric unit is configured to selectively drive one of the rotatable housing and the input shaft.

12. The hybrid transmission system of claim 9, wherein the electric unit is configured to selectively generate electrical energy with the rotation of one of the rotatable housing and the input shaft.

13. The hybrid transmission system of claim 9 further including:
a first gear assembly driven by the rotatable housing, and
a second gear assembly driven by the hydraulic rotor, the second gear assembly being coupled to the first gear assembly to provide a combined output to drive the output shaft.

14. The hybrid transmission system of claim 13, wherein one of the first gear assembly and the second gear assembly is a planetary gearing mechanism.

15. The hybrid transmission system of claim 9, wherein the hydraulic rotor is one of an axial piston motor, a radial piston motor, and a vane type motor.

16. A machine comprising:
a mechanical power source;
a hydraulic power source; and
a hybrid transmission system, the hybrid transmission system including:
a stationary housing,
an input shaft and an output shaft mounted within the stationary housing for rotation about a central axis, the input shaft and the output shaft are rotatably coupled to the stationary housing,
a rotatable housing mounted within the stationary housing for rotation about the central axis, the rotatable housing being connected to the input shaft to drive the output shaft, and
a hydraulic rotor mounted within the rotatable housing in a coaxial alignment with the input shaft and the output shaft, the hydraulic rotor drives the output shaft, the hydraulic rotor being configured to be selectively engaged and disengaged to the rotatable housing.

17. The machine of claim 16 further including a clutch member associated with the rotatable housing to selectively engage and disengage the hydraulic rotor to the rotatable housing.

18. The machine of claim 16 further including an electric unit associated to one of the rotatable housing and the input shaft.

19. The machine of claim 18, wherein the electric unit is configured to selectively drive one of the rotatable housing and the input shaft.

20. The machine of claim 18, wherein the electric unit is configured to selectively generate electrical energy with the rotation of one of the rotatable housing and the input shaft.
